(19) United States
(12) Patent Application Publication
(10) Pub. No.: US 2013/0071206 A1
(43) Pub. Date: Mar. 21, 2013

(54) LOOSE-LEAF PUNCHING-AND-BINDING MACHINE

(71) Applicant: Tung-Lung Chiang, Yunlin County (TW)

(72) Inventor: Tung-Lung Chiang, Yunlin County (TW)

(21) Appl. No.: 13/233,191

(22) Filed: Sep. 15, 2011

(51) Int. Cl. B42B 5/08

(52) U.S. Cl. 412/38

(57) ABSTRACT

A loose-leaf punching-and-binding machine includes a base, a punching unit for forming binding holes on a loose leaf and a binding unit including recess sets. Each of the recess sets is constructed from a plurality of positioning recesses for matching fasteners of various sizes. Each of the positioning recesses has an opening for allowing the fitting fastener to pass therethrough and rest in the positioning recess. The positioning recess is mainly defined by a horizontal propping surface and a vertical retaining surface. The retaining surfaces of the positioning recesses of the same recess set are separated from the openings thereof differently for matching fasteners of different sizes. Thereby, a fastener of any size, when placed in the fitting positioning recess, is properly exposed at the opening, thereby facilitating installation of the fastener into the binding hole of the loose leaf.

### BACKGROUND OF THE INVENTION

1. Technical Field

The present invention relates to paper binding machines, and more particularly, to a loose-leaf punching-and-binding machine working with disk-like fasteners of various sizes to bind a stack of loose leaves.

2. Description of Related Art

U.S. Pat. No. 5,553,959 has disclosed a notebook system, wherein a line of equidistant mushroom-shaped openings is formed along one edge of a stack and each of the openings is configured to receive a fastener (fastening member/disk-like member), so that the pages can be bound and turned about the edge held by the fasteners.

To construct the prior-art notebook system, a conventional binding machine with a punching unit is used to first form the stack of sheets with the mushroom-shaped openings. The binding machine has its base 1 provided with a line of equidistant seat members 2 at one side, as shown in FIG. 1. Each of the seat members 2 includes an entry 3 for a fastener to be placed into the seat members 2 therethrough. Also, each of the seat members 2 contains a retainer 4 (as depicted in FIG. 2). All the retainers 4 are connected with a adjuster lever 5 that is operably provided on the base 1, so that by operating the adjuster lever 5, the retainers 4 can be properly positioned according to the size of the fasteners in use (as shown in FIGS. 2 and 3), thereby preventing the fasteners of relatively small sizes from sinking into the seat members 2 and failing to contact the corresponding mushroom-shaped openings.

However, the existing binding machine is structurally complex, so it is expensive to produce and has higher maintaining requirements.

### SUMMARY OF THE INVENTION

The conventional loose-leaf punching-and-binding machine is inconvenient in use because the adjuster lever has to be operated when fasteners of different sizes are applied to the prior-art device for preventing a small fastener from falling deeply in the seat member and failing to reach the binding hole. To overcome the above-mentioned defect, the present invention herein provides a loose-leaf punching-and-binding machine, which can readily work with fasteners of various sizes, while being simple in structure and requiring least maintenance.

According to the present invention, a loose-leaf punching-and-binding machine comprises:

a base having a first side and a second side;

a punching unit deposited on the first side of the base, for forming a line of binding holes at an edge of at least one loose leaf, wherein each of the binding holes is configured to receive a disk-like fastener;

a binding unit including a plurality of recess sets arranged along the second side of the base, each said recess set having a series of positioning recesses that are arranged equidistantly in order of sizes of the fasteners fitting the positioning recesses, each said positioning recess having an opening for allowing the fitting fastener to pass therethrough and rest in the positioning recess, each said positioning recess being mainly defined by a horizontal propping surface and a vertical retaining surface, and the retaining surfaces of the positioning recesses of the same recess set being separated from the openings thereof differently for matching the fasteners of different sizes, so that a fastener placed in the fitting positioning recess is properly exposed at the opening, thereby facilitating installation of the fastener into the binding hole of the loose leaf.

The primary objective of the present invention is that in virtue of the positioning recesses of various sizes, the invention allows binding paper to be easily done by placing fasteners in positioning recesses corresponding thereto in size, without any additional adjustment, thereby ensuring smooth binding operation.

Another objective of the present invention is that since the traditional adjusting mechanism is not used in the present invention, there is no risk of mechanical failure. The structure is relatively simple, so the costs for production and maintenance can be significantly reduced as compared with the prior-art device.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a conventional loose-leaf punching-and-binding machine;

FIG. 2 and FIG. 3 are schematic drawings illustrating how the conventional loose-leaf punching-and-binding machine works;

FIG. 4 is a perspective view of a device according to the present invention;

FIG. 5 is a top view of the device according to the present invention;

FIG. 6 is a schematic drawing showing the device according to the present invention binding loose leaves; and

FIG. 7 and FIG. 8 are schematic drawings illustrating how the device according to the present invention works.

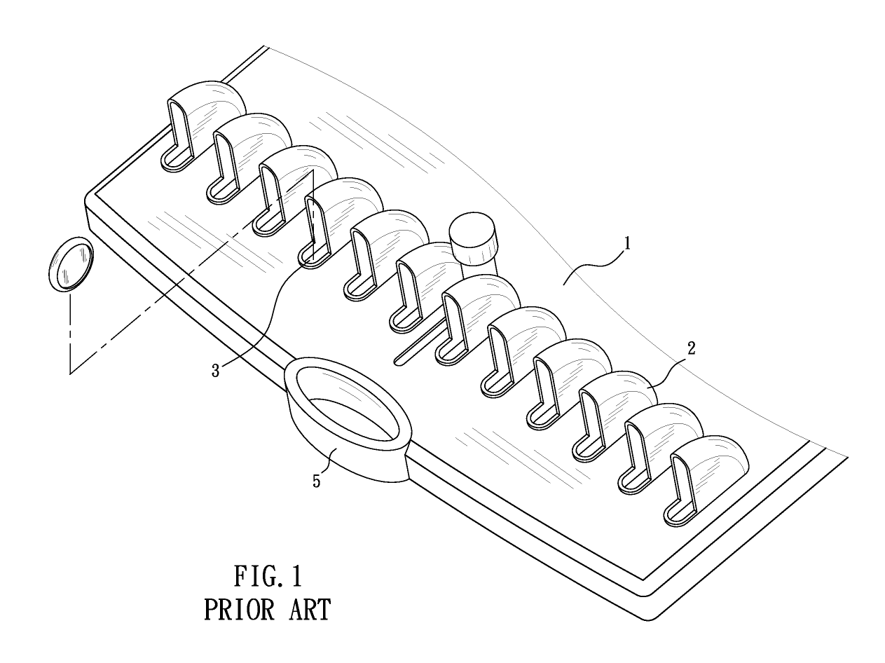

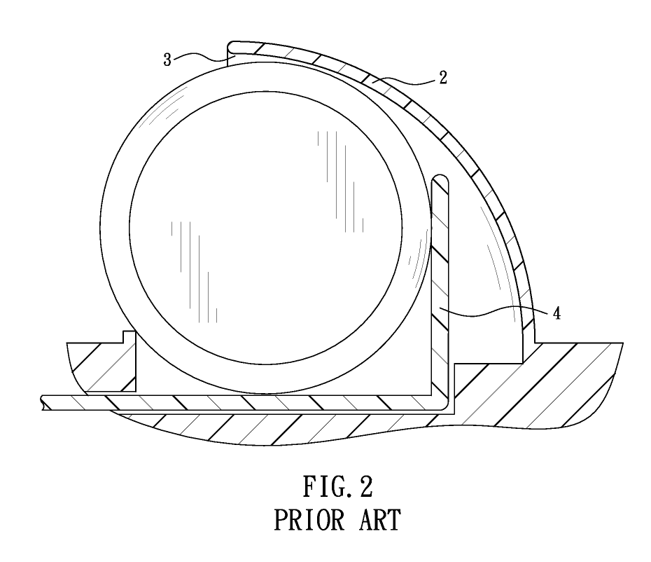

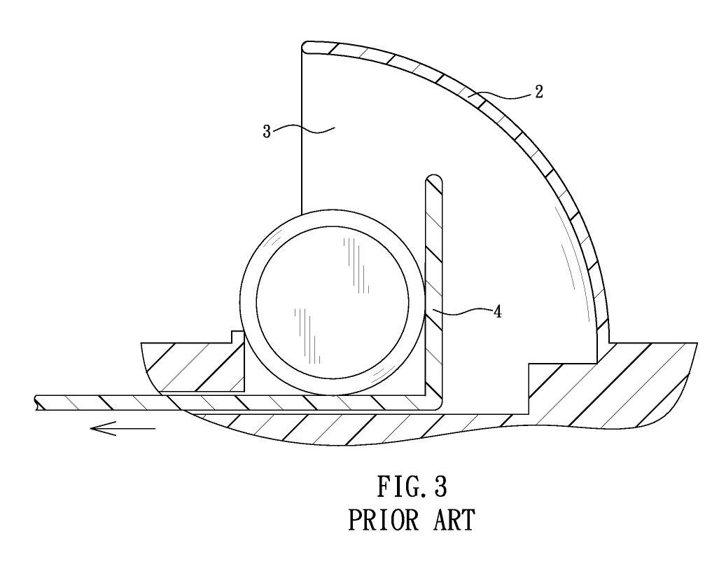

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale. In addition, unless otherwise noted, like elements will be identified by identical numbers throughout all figures.

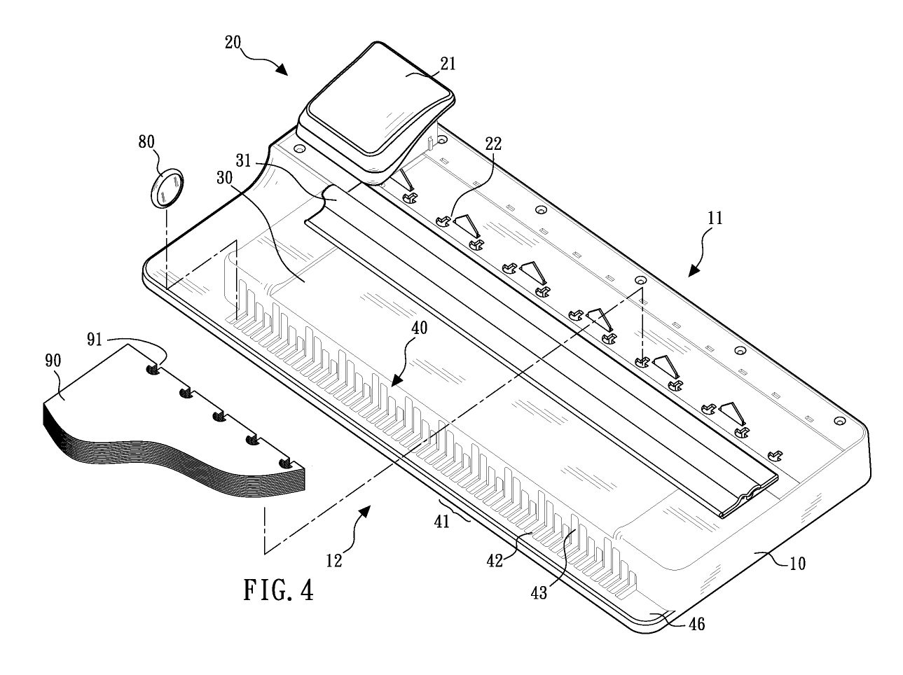

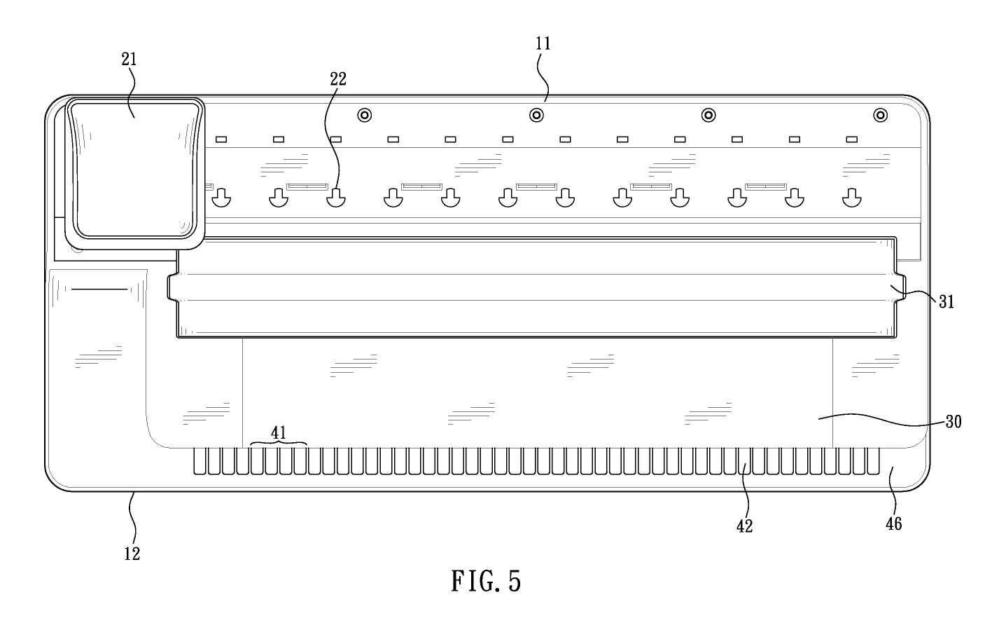

Referring to FIG. 4 through FIG. 6, according to the present invention, a loose-leaf punching-and-binding machine is primarily composed of a base 10, a punching unit 20, a platform 30 and a binding unit 40.

The base 10 includes a first side 11 and a second side 12.

The punching unit 20 is deposited at the first side 11 of the base 10. The punching unit 20 includes a puncher 21 movable along the first side 11, and a line of equidistant forming holes 22 along the first side 11. The puncher 21 is configured to work with the forming holes 22 to form a line of mushroom-shaped binding holes 91 along an edge of a loose leaf 90. Each of the binding holes 91 is configured to receive and retain a disk-like fastener 80.

The platform 30 is located between the first side 11 and the second side 12 of the base 10. The platform 30 is equipped with a clip 31 for fixing the loose leaf 90 to the platform 30.

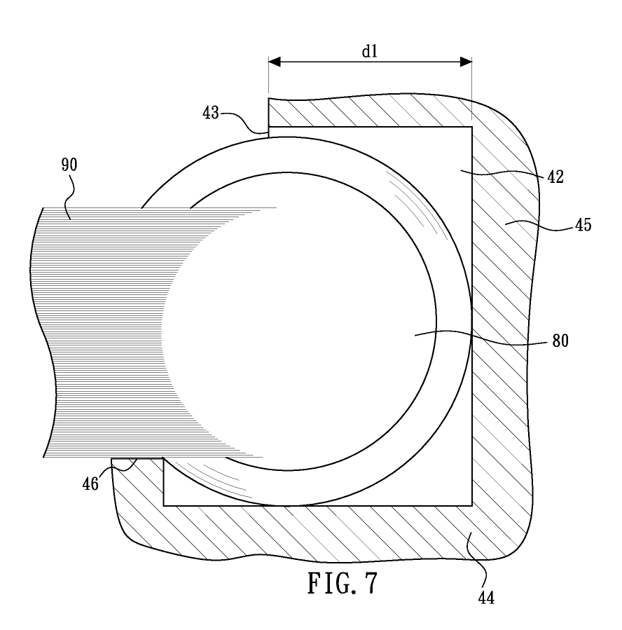

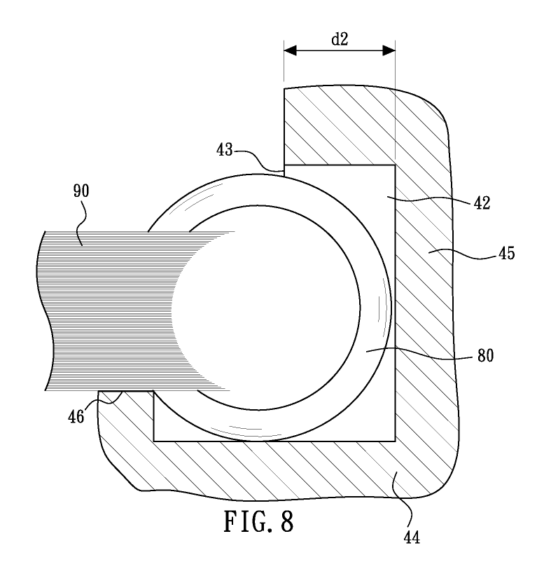

The binding unit 40 includes a plurality of recess sets 41 aligned at the second side 12 of the base 10. Each of the recess sets 41 is composed of a plurality of positioning recesses 42. The positioning recess 42 has an opening 43 allowing the fastener 80 to be rested in the positioning recess 42. The positioning recess 42 is mainly defined by a horizontal propping surface 44 and a vertical retaining surface 45 (as shown in FIG. 7 and FIG. 8), so that the positioning recess 42 provides an L-shaped cove to support the fastener 80. The retaining surfaces 45 of the positioning recesses 42 in each said recess set 41 are different for matching fasteners 80 of various sizes so as to allow a fastener 80 rested in a said matching positioning recess 42 has a part exposed at the opening 43. The binding unit 40 further has a supporting edge 46 at the second side 12 jutting out of the openings 43.

With the configuration described above, the present invention can function as below.

For binding a stack of loose leaves 90, the stack is such placed on the platform 30 that a binding edge of the loose leaf 90 corresponds the punching unit 20, and then positioned by the clip 31, so that under the cooperation of the puncher 21 and the forming holes 22, a line of equidistant binding holes 91 is formed along the binding edge of the loose leaves 90.

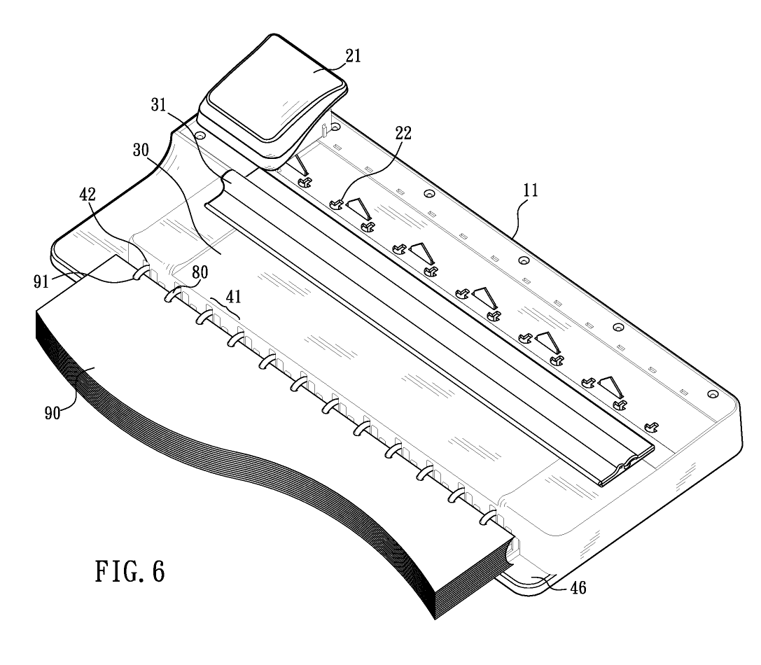

As shown in FIG. 6, fasteners 80 chosen according to the thickness of the stack of the loose leaves 90 are placed into the positioning recesses 42 fitting their size. Since the positioning recesses 42 of the same size in all the recess sets 41 are spaced equidistantly with an interval therebetween equal to that between the forming holes 22, the loose leaves 90 with the binding holes 91, when placed on the supporting edge 46, can have the binding holes 91 readily aligned with the corresponding fasteners 80 rested in the positioning recesses 42.

Because the retaining surface 45 and opening 43 of the positioning recess 42 are designed to allow the fitting fastener 80 to be exposed at the opening 43, as described above, the loose leaves 90 can be easily bound by the fasteners 80 fitting the binding holes 91.

For instance, as shown in FIG. 7, the larger positioning recess 42 has a width d1 between the retaining surface 45 and the opening 43 larger, for working with a relatively large fastener 80. On the other hand, as shown in FIG. 8, the smaller positioning recess 42 has a width d2 between the retaining surface 45 and the opening 43 smaller, for working with a relatively small fastener 80. In virtue of the positioning recesses 42 of various sizes, the invention allows binding paper to be easily done by placing fasteners 80 in positioning recesses 42 corresponding thereto in size, without any additional adjustment so as to prevent small fasteners from falling too deep in the positioning recesses to be properly exposed, and prevent large fasteners from failing to fit into the positioning recesses, thereby ensuring smooth binding operation.

Meantime, as the traditional adjusting mechanism is not used in the present invention, there is no risk of mechanical failure. The structure is relatively simple, so the costs for production and maintenance can be significantly reduced as compared with the prior-art device.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A loose-leaf punching-and-binding machine, comprising:
a base having a first side and a second side;
a punching unit deposited on the first side of the base, for forming a line of binding holes at an edge of at least one loose leaf, wherein each of the binding holes is configured to receive a disk-like fastener;
a binding unit including a plurality of recess sets arranged along the second side of the base, each said recess set having a series of positioning recesses that are arranged equidistantly in order of sizes of the fasteners fitting the positioning recesses, each said positioning recess having an opening for allowing the fitting fastener to pass therethrough and rest in the positioning recess, each said positioning recess being mainly defined by a horizontal propping surface and a vertical retaining surface, and the retaining surfaces of the positioning recesses of the same recess set being separated from the openings thereof differently for matching the fasteners of different sizes, so that a fastener placed in the fitting positioning recess is properly exposed at the opening, thereby facilitating installation of the fastener into the binding hole of the loose leaf.

2. The loose-leaf punching-and-binding machine of claim 1, wherein each of the positioning recesses provides an L-shaped cove.

3. The loose-leaf punching-and-binding machine of claim 1, wherein the binding unit includes a supporting edge on the second side jutting out of the openings.

4. The loose-leaf punching-and-binding machine of claim 1, wherein each of the binding holes is a mushroom-shaped binding hole.

5. The loose-leaf punching-and-binding machine of claim 1, wherein a platform is provided on the base between the first side and the second side, and a clip is provided on the platform for fixing the loose leaf to the platform.

6. The loose-leaf punching-and-binding machine of claim 1, wherein the punching unit includes a puncher movable along the first side, and a line of equidistant forming holes formed on the first side.
